(19) United States
(12) Patent Application Publication
(10) Pub. No.: US 2012/0242110 A1
(43) Pub. Date: Sep. 27, 2012

(54) Motorpod Compartment and Vehicle

(76) Inventor: Nicholas Louis Geranio, Haleiwa, HI (US)

(21) Appl. No.: 13/053,049

(22) Filed: Mar. 21, 2011

(51) Int. Cl. B62D 33/06

(52) U.S. Cl. 296/190.08

(57) ABSTRACT

Described is a motorpod compartment for a vehicle in which the compartment includes a cockpit having a base and a canopy that join to define an interior space configured to receiving therein an operator. The compartment further includes a pair of frame attachment arms, each pivotally connected to the cockpit and selectively, pivotally connectable to one of a pair of motorcycles.

### FIELD OF THE INVENTION

The invention generally relates to a four-wheel, roadable vehicle, and more particularly to a compartment and vehicle in which the compartment is selectively-connectable.

### BACKGROUND OF THE INVENTION

Common four-wheeled, roadable vehicles are often expensive to acquire and to replace. Two-wheeled, roadable motorcycles, on the other hand, are often less expensive than the common automobile, but do not provide the operator much protection from the elements or the other luxuries that are available to an operator and passengers riding within the main compartment of a common automobile.

### SUMMARY OF THE INVENTION

The present motorpod compartment and vehicle provide an enclosed cockpit that is selectively connectable to a pair of motorcycles. As such, an operator can ride within the cockpit under the power of two connected motorcycles. When desired, the cockpit can be disconnected from the motorcycles such that the motorcycles can then be used in the same manner as conventional motorcycles.

The cockpit includes a base and a canopy. The base and canopy selectively join along an edge of the base and an edge of the canopy. In some embodiments, the base and canopy are completely detachable from one another. In other embodiments, the base and canopy are pivotally connected via a hinge. When the base is joined with the canopy, the base and canopy define an interior space configured for carrying therein the operator of the motorpod. A steering mechanism, operatively connectable with the motorcycles, is included within the interior space.

Frame attachment arms pivotally connect the cockpit with the motorcycles. The frame attachment arms are attached, at one end, to the cockpit via a pivot connection, and, at the other end, to the motorcycles via a pivot connection, where such connection is selectively connectable. The pivoting connection between the motorcycles, frame attachment arms, and cockpit allow the cockpit to lean with the motorcycles, such as when the motorpod vehicle turns, while maintaining connection.

In some embodiments, the frame attachment arms are directly connected to a pivot bar that accomplishes the pivot connection between the frame attachment arms and the cockpit.

Being connectable to a pair of conventional motorcycles, the present motorpod compartment and vehicle provides a four-wheeled, roadable vehicle that is relatively inexpensive to acquire and replace. Replacing one of the pair of motorcycles does not necessarily require replacement of the other motorcycle or of the cockpit.

Because the cockpit is selectively detachable from the motorcycles, one motorpod vehicle provides the means for transporting one or more people in an enclosed, four-wheel vehicle, and then, after disconnecting the cockpit from the pair of motorcycles, transporting one or more people via one or both of the pair of traditional motorcycles.

The purpose of the Summary is to enable the public, and especially the scientists, engineers, and practitioners in the art who are not familiar with patent or legal terms or phraseology to determine quickly, from a cursory inspection, the nature and essence of the technical disclosure of the application. The Summary is neither intended to define the invention of the application, which is measured by the claims, nor is it intended to be limiting as to the scope of the invention in any way.

Still other features and advantages of the claimed device will become readily apparent to those skilled in the art from the following detailed description describing preferred embodiments of the device, simply by way of illustration of the best mode contemplated by carrying out the device. As will be realized, the device is capable of modification in various obvious respects all without departing from the invention. Accordingly, the drawings and description of the preferred embodiments are to be regarded as illustrative, and not restrictive.

### BRIEF DESCRIPTION OF THE DRAWINGS

FIG. 1 is a left side, elevation view of a cockpit of a motorpod vehicle according to a first embodiment.

FIG. 2 is a top plan view of a cockpit of a motorpod vehicle according to the first embodiment.

FIG. 3 is an isometric view of the front and left sides of a cockpit of a motorpod vehicle according to the first embodiment.

FIG. 4 is an isometric view of the left and rear sides of a cockpit of a motorpod vehicle according to the first embodiment.

FIG. 5 is an isometric view of the right side of a cockpit of a motorpod vehicle according to the first embodiment.

FIG. 6 is an isometric view of the front side of a motorpod vehicle according to the first embodiment arranged in an upright position.

FIG. 7 is a front, elevation view of a motorpod vehicle according to the first embodiment arranged in an upright position.

FIG. 8 is a front elevation view of a motorpod vehicle according to the first embodiment arranged in a tilted position.

FIG. 9 is a left side, elevation view of a cockpit of a motorpod vehicle according to a second embodiment with a partial view of a connected motorcycle attachment subassembly.

### DESCRIPTION OF THE PREFERRED EMBODIMENTS

While the motorpod compartment and vehicle are susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “e.g.,” “etc.,” and “or” indicates non-exclusive alternatives without limitation unless otherwise noted. The use of “including” means “including, but not limited to,” unless otherwise noted.

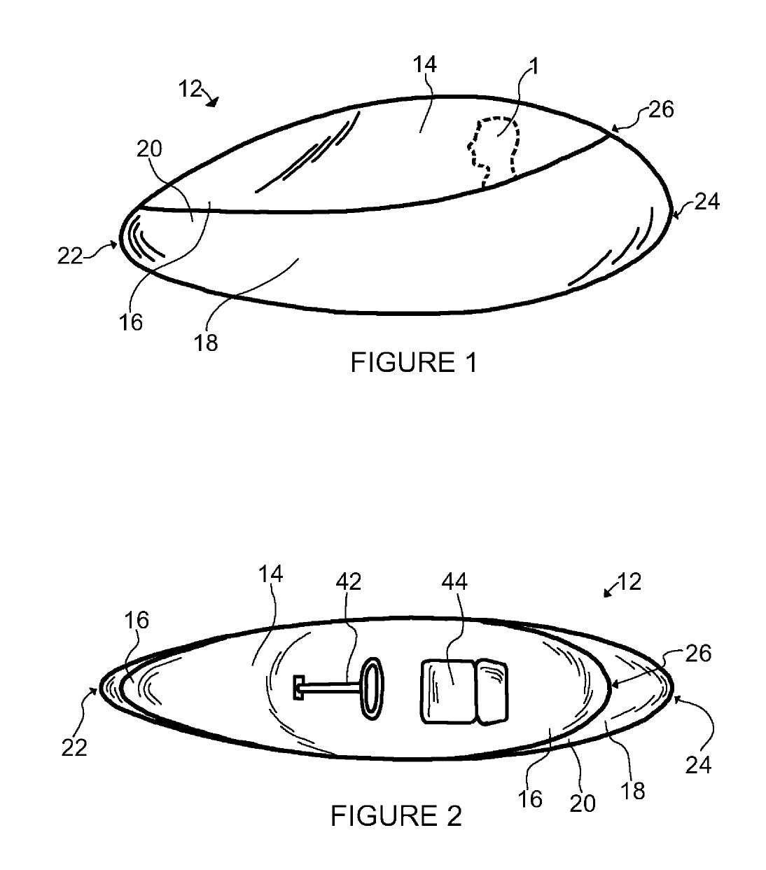

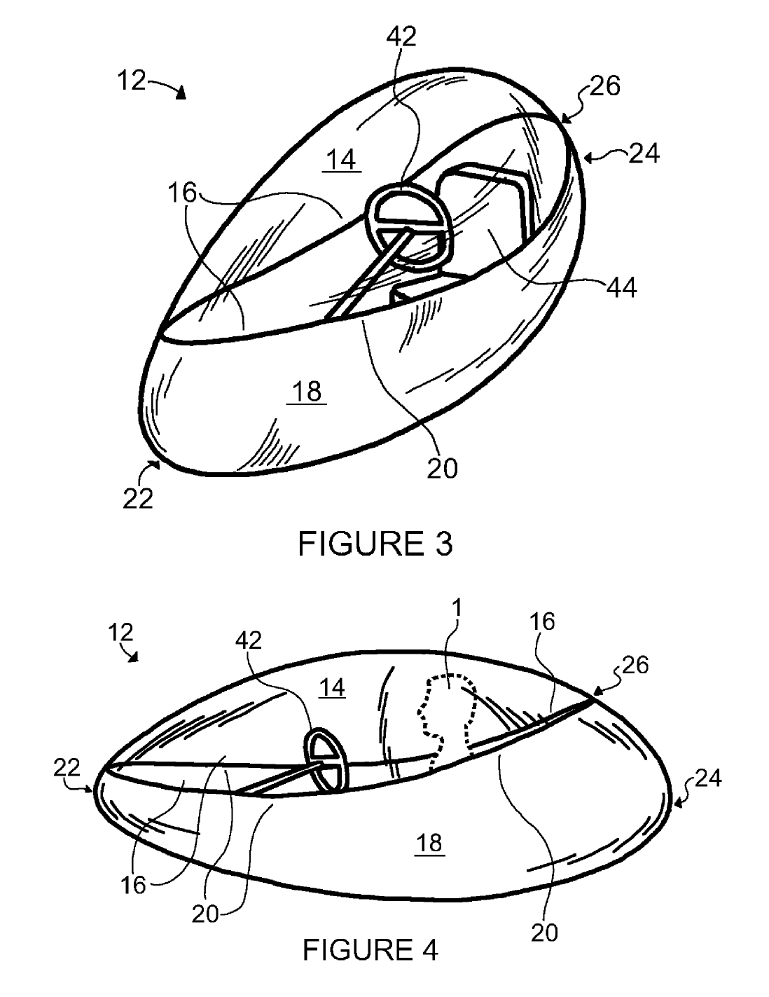

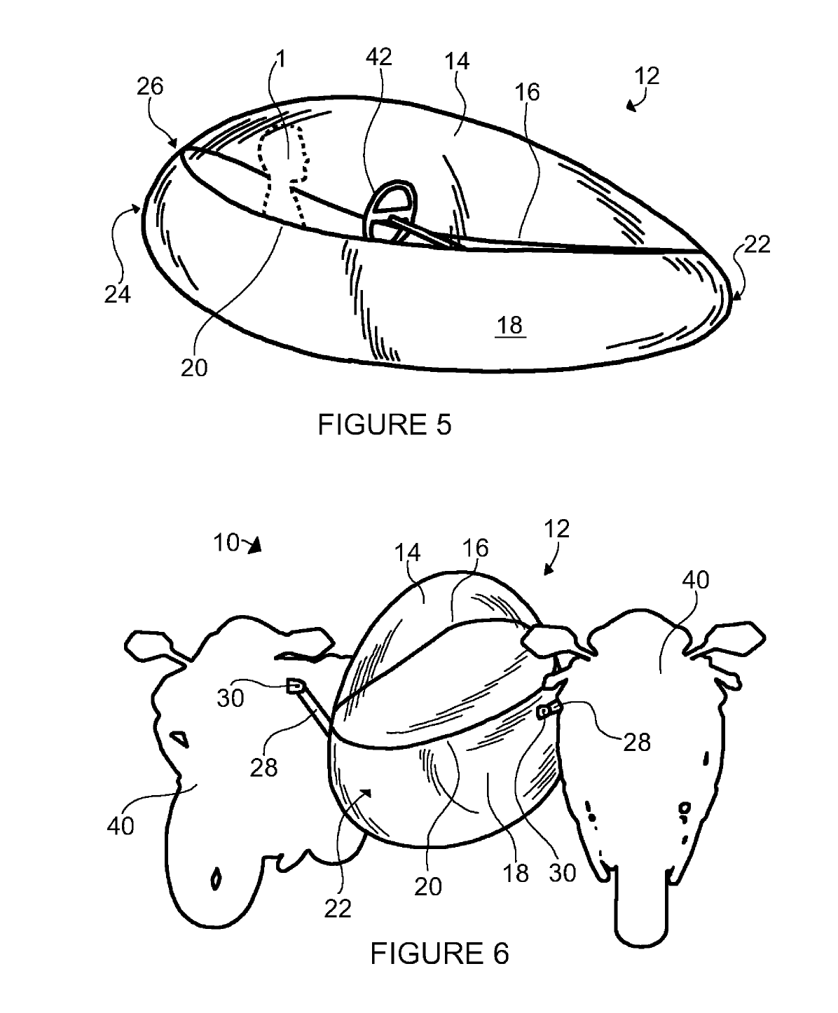

As shown in FIGS. 1 through 9, the present motorpod compartment and vehicle provide a lightweight, relatively inexpensive, passenger transport cab that is selectively mountable to a pair of conventional motorcycles so as to form a motorpod vehicle capable of transporting a passenger within the compartment at high speed along a roadway.

The first embodiment of a motorpod vehicle 10 is depicted in FIGS. 1 through 8. With particular attention to FIGS. 1 through 6, depicted is a preferred embodiment of a cockpit 12 of a motorpod compartment of a roadable vehicle. The cockpit 12 includes a base 18 and a canopy 14. The base 18 has a base joining edge 20, and the canopy 14 has a canopy joining edge 16. The canopy joining edge 16 is joinable with the base joining edge 20. According to the embodiment depicted in FIG. 1, the base joining edge 20 of the base 18 is the upper edge of the base 18. Also according to the embodiment depicted, the canopy joining edge 16 of the canopy 14 is the lower edge of the canopy 14. In some embodiments, the base joining edge 20 and canopy joining edge 16 are joinable so as to abut one another. In other embodiments, the base joining edge 20 and canopy joining edge 16 are joinable such that the base joining edge 20 at least partially overlaps the canopy joining edge 16. Preferably, the base joining edge 20 and canopy joining edge 16 join to form a water-tight seal. Also, preferably, the base joining edge 20 and canopy joining edge 16 join smoothly such that the surface of the cockpit 12 is smooth, with minimized surface topography.

When the base joining edge 20 is joined with the canopy joining edge 16, the base 18 and canopy 14 define an interior space configured to seat a passenger, such as an operator 1, inside the cockpit 12. Preferably, the interior space also includes a seat 44, supported by the base 18, upon which the operator 1 can sit while riding within the cockpit 12. Although the depicted embodiment shows a single passenger, i.e., the operator 1, in other embodiments, the cockpit 12 is configured to seat more than one passenger, such as an operator 1 and a co-passenger.

So as to allow the operator 1, and any other occupants, to see outside of the cockpit 12, the canopy 14 is preferably made of a translucent material, such as glass or a transparent thermoplastic. The base 18, according to some embodiments, is made of fiberglass. In other embodiments, the base 18 is made of carbon fiber.

With particular attention to FIGS. 6 through 9, connected to the cockpit 12 is a motorcycle attachment subassembly. According to the embodiment depicted in FIGS. 6 to 8, the motorcycle attachment subassembly comprises a pair of frame attachment arms 28, each connected to the base 18 of the cockpit 12 via a pivot connection 30. Each frame attachment arm 28 is also selectively, pivotally connectable to one of the pair of motorcycles 40, again via a pivot connection 30. Therefore, each frame attachment arm 28 is configured to at least partially pivot about the pivot connection 30 at the first end of the frame attachment arm 28, supported by the cockpit 12, and to also at least partially pivot about the pivot connection 30 at the second end of the frame attachment arm 28, supported by a motorcycle 40, when the cockpit 12 is connected to a pair of motorcycles 40.

According to the first depicted embodiment, the two frame attachment arms 28 are positioned opposite one another on either side of the cockpit 12. As shown in FIG. 6, for example, according to the depicted embodiments, the frame attachment arms 28 are connected to the base 18 of the cockpit 12. Preferably, the height along the cockpit at which the frame attachment arms 28 are connected to the cockpit 12 is a higher, i.e., further away from the ground, than the motorpod vehicle's center of gravity.

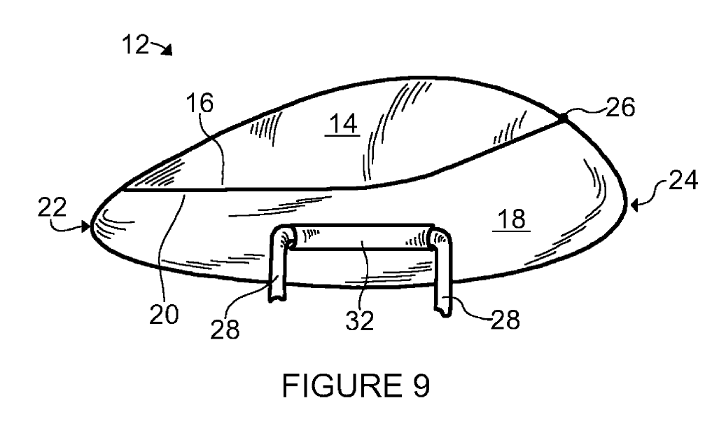

With particular attention to FIG. 9, the motorcycle attachment subassembly, according to the depicted second preferred embodiment, comprises a pair of pivot bars 32, one attached to each side of the cockpit 12. Each pivot bar 32 is supported by the base 18 of the cockpit 12. Each pivot bar 32 has a first end and a second end with the center axis of the pivot bar 32 passing therethrough between the first end and the second end. Each pivot bar 32 is configured to turn about the center axis. Two pairs of frame attachment arms 28 are also included within the motorcycle attachment subassembly. One frame attachment arm 28 of each pair extends from the first end of each of the pivot bars 32. Another frame attachment arm 28 of each pair extends from the second end of each of the pivot bars 32. According to the depicted embodiment, the frame attachment arms 28 connected to the ends of the pivot bar 32 are fixedly connected and extend from the pivot bar 32. Accordingly, as the pivot bar 32 turns about its center axis, the connected frame attachment arms 28 pivot about the center axis of the pivot bar 32. The other end of the each frame attachment arm 28, i.e., the end that is not connected to a pivot bar 32, is selectively, pivotally connectable to a motorcycle 40.

As shown in FIG. 6 through 8, when the cockpit 12 is selectively connected to a pair of motorcycles 40 via the frame attachment arms 28, the assembled motorpod vehicle 10 is a four-wheeled vehicle suitable for use on a roadway. That is, the cockpit 12 is carried and supported by the motorcycles 40. According to the depicted embodiments, the cockpit 12 has no direct contact with the ground 3 and does not include wheels of its own. The motorpod vehicle 10 is powered by the combined power of the two engines in the paired motorcycles 40. Further, according to the depicted embodiments, to be roadable, the motorpod vehicle 10 relies upon the four wheels supplied by the pair of motorcycles 40.

According to the depicted embodiments, within the interior space of the cockpit 12 is located in a steering mechanism 42, such as a steering wheel and steering column. The steering mechanism 42 is operatively connectable with the pair of motorcycles 40. Accordingly, when an operator 1 is operating the motorpod vehicle 10 within the cockpit 12, the operator 1, through manipulation of the steering mechanism 42, can remotely operate the pair of motorcycles 40.

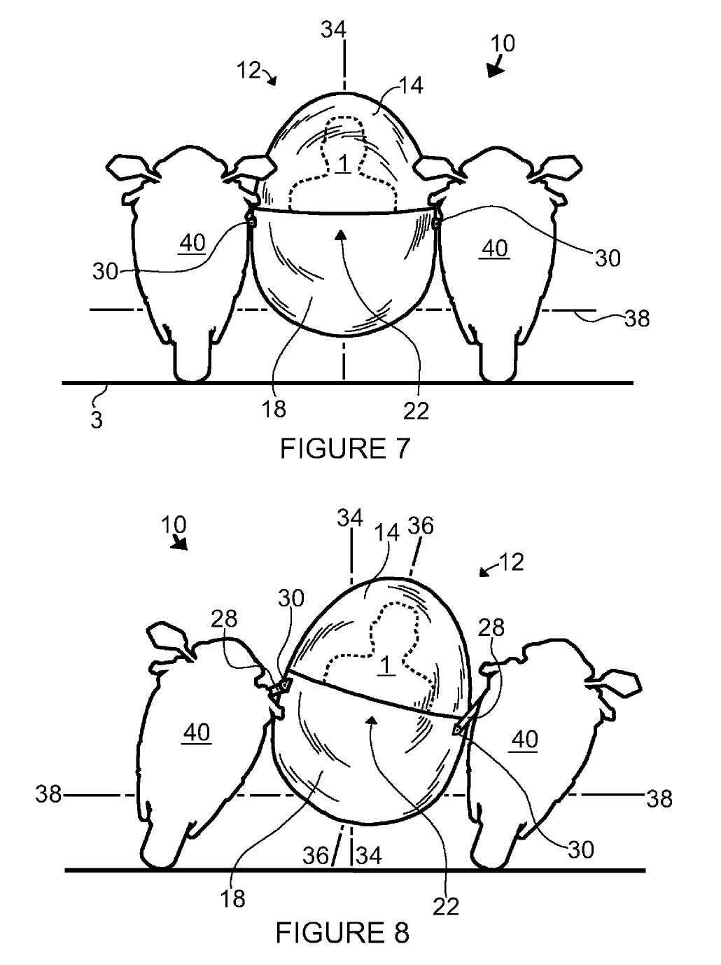

In operation, the motorpod vehicle 10 is configured to allow the cockpit 12 to lean from an upright position, depicted in FIG. 7, in which the height of the cockpit 12 aligns with an upright axis 34 that is essentially perpendicular to a horizontal axis 38 parallel to the ground 3, to a tilted position, depicted in FIG. 8, in which the height of the cockpit 12 defines a tilt axis 36 that is angled away from the upright axis 34 and toward the horizontal axis 38. Correspondingly, the motorpod vehicle 10 is configured to allow the cockpit 12 to lean back from the tilted position to the upright position. Whether positioned in the upright position or a tilted position the cockpit 12 remains connected to and supported by the motorcycles 40 via the frame attachment arms 28. The pivoting connections between the frame attachment arms 28, the cockpit 12, and the motorcycles 40 accommodate the tilting of the cockpit 12 and motorcycles 40. Thus, just as a motorcycle 40 leans during a turn, the motorpod vehicle 10 is configured to lean such that the pair of motorcycles 40 lean and the cockpit 12 leans during a turn. Preferably, the steering mechanism 42 of the cockpit 12 further includes a gyroscopic stabilization mechanism.

As shown in FIGS. 1 through 9, according to the depicted embodiments, the joined canopy 14 and base 18 form a pod-like or egg-shaped cockpit 12. As such, the cockpit 12 tapers in height and width from a mid region to the nose 22 of the cockpit 12. The cockpit 12 also tapers in height and width from a mid region to the tail 24 of the cockpit 12. As such, the cockpit 12 of the motorpod vehicle 10 is streamlined.

The cockpit 12 of the motorpod vehicle 10 is openable so as to expose the interior space within. In some embodiments, the cockpit 12 is opened by completely detaching the canopy 14 from the base 18. In other embodiments, such as that shown in FIG. 9, the canopy 14 is affixed to the base 18 via a hinge 26 connecting the canopy joining edge 16 and base joining edge 20 in an area proximate to the tail 24 of the cockpit 12. Therefore, the canopy 14 is pivotally connected to the base 18, and the canopy 14 is configured to at least partially pivot about the hinge 26 in being opened from the closed position, shown in FIG. 9, to an open position in which the front of the canopy 14 has been pivoted away from the nose 22 of the cockpit 12. In the open position, ingress and egress from the interior of the cockpit 12 is allowed. The canopy 14 can then be repositioned to the closed position.

In some embodiments, even with the canopy detached or pivoted to the open position, the cockpit 12 is still functional within the motorpod vehicle 10 via connection of the base 18 to the pair of motorcycles 40. Thus, a type of convertible motorpod vehicle 10 configuration is achievable.

Because the frame attachment arms 28 are selectively connectable to the motorcycles 40, when the motorpod vehicle 10 is not in use, the frame attachment arms 28 can be selectively detached from the motorcycles 40. When detached, the motorcycles 40 may be utilized as any other conventional motorcycle 40. When use of the motorpod vehicle 10 is desired, the frame attachment arms 28 can be selectively reattached to the motorcycles 40.

The exemplary embodiments shown in the figures and described above illustrate, but do not limit, the invention. It should be understood that there is no intention to limit the invention to the specific forms disclosed; rather, the invention is to cover all modifications, alternative constructions, and equivalents falling within the spirit and scope of the invention as defined in the claims. For example, while the exemplary embodiments illustrate a steering mechanism of a steering wheel design, the invention is not limited to use with a steering wheel, but may be used with other controls, such as a joystick. Hence, the foregoing description should not be construed to limit the scope of the invention, which is defined in the following claims. Therefore, while there is shown and described the present preferred embodiments of the motorpod compartment and vehicle, it is to be distinctly understood that this invention is not limited thereto but may be variously embodied to practice within the scope of the following claims. From the foregoing description, it will be apparent that various changes may be made without departing from the spirit and scope of the invention, as defined by the following claims.

What is claimed is:

1. A motorpod compartment for a roadable vehicle, said motorpod compartment comprising:
a cockpit comprising
a base having a base joining edge;
a canopy having a canopy joining edge, said canopy joining edge being joinable with said base joining edge such that said base and said canopy define an interior space configured to receive therein an operator; and
a motorcycle attachment subassembly connected to said cockpit, said motorcycle attachment subassembly comprising:
a pair of frame attachment arms, each being connected to said cockpit via a pivot connection, each of said frame attachment arms being configured to selectively, pivotally connect to one of a pair of motorcycles.

2. The motorpod compartment of claim 1, wherein said cockpit further comprises a steering mechanism operatively connectable to said pair of motorcycles, said steering mechanism being controllable by said operator.

3. The motorpod compartment of claim 1, wherein said cockpit defines a nose and a tail, said cockpit tapering in width and height toward said nose and tapering in width and height toward said tail; whereby said cockpit is streamlined.

4. The motorpod compartment of claim 1, wherein said canopy is selectively, completely detachable from said base.

5. The motorpod compartment of claim 1, wherein said canopy is pivotally connected to said base via a hinge.

6. The motorpod compartment of claim 5, wherein
said cockpit defines a nose and a tail; and
said hinge is attached to said canopy joining edge and to said base joining edge proximate to said tail;
whereby said cockpit is openable via pivoting said canopy about said hinge.

7. The motorpod compartment of claim 1, wherein said cockpit further comprises a seat supported by said base and contained within said interior space.

8. The motorpod compartment of claim 1, wherein said canopy comprises a translucent material.

9. The motorpod compartment of claim 1, wherein said base comprises fiberglass.

10. The motorpod compartment of claim 1, wherein said base comprises carbon fiber.

11. A motorpod vehicle for transporting at least one passenger on a roadway, said motorpod vehicle comprising:
a pair of motorcycles;
a motorcycle attachment subassembly selectively, pivotally connected to said pair of motorcycles;
a cockpit pivotally connected to said motorcycle attachment subassembly, said cockpit comprising:
a base having a base joining edge;
a canopy having a canopy joining edge, said canopy joining edge being joinable with said base joining edge such that said base and said canopy define an interior space configured to receive therein said passenger;
whereby said cockpit is configured to lean from an upright position to a tilted position as said pair of motorcycles also lean.

12. The motorpod vehicle of claim 11, wherein said cockpit further comprises a steering mechanism operatively connectable to said pair of motorcycles, said steering mechanism being controllable by said passenger.

13. The motorpod vehicle of claim 11, wherein said cockpit defines a nose and a tail, said cockpit tapering in width and height toward said nose and tapering in width and height toward said tail, whereby said cockpit is streamlined.

14. The motorpod vehicle of claim 11, wherein said canopy is selectively, completely detachable from said base.

15. The motorpod vehicle of claim 11, wherein said canopy is pivotally connected to said base via a hinge.

16. The motorpod vehicle of claim 15, wherein
said cockpit defines a nose and a tail; and
said hinge is attached to said canopy joining edge and to said base joining edge proximate to said tail;
whereby said cockpit is openable via pivoting said canopy about said hinge.

17. The motorpod vehicle of claim 11, wherein said cockpit further comprises a seat supported by said base and contained within said interior space.

18. The motorpod vehicle of claim 11, wherein said canopy comprises a translucent material.

19. The motorpod vehicle of claim 11, wherein said motorcycle attachment subassembly comprises a pair of frame attachment arms, each being selectively, pivotally connected to one of said pair of motorcycles, each of said pair of frame attachment arms also being pivotally connected to said cockpit.

20. The motorpod vehicle of claim 11, wherein said motorcycle attachment subassembly comprises
a pair of pivot bars supported by said base of said cockpit, each said pivot bar having a first end a second end and defining therebetween a central axis, each said pivot bars being configured to turn about its respective central axis;
two pairs of frame attachment arms, one frame attachment arm of each pair extending from said first end of each of said pivot bars and another of said frame attachment arm of each pair extending from said second end of each of said pivot bars, each of said pair of frame attachment arms being selectively, pivotally connected to one of said pair of motorcycles;
wherein, when said cockpit leans from said upright position to said tilted position, said motorcycles also lean while staying in connection with said cockpit.
